(19) United States
(12) Patent Application Publication
(10) Pub. No.: US 2024/0424940 A1
(43) Pub. Date: Dec. 26, 2024

(54) GOSSIP NETWORK FOR ELECTRIC VEHICLE SERVICE EQUIPMENT UPDATES AND PAYMENT SETTLEMENT

(71) Applicant: Loop Global Inc., El Segundo, CA (US)

(72) Inventors: Dustin Cavanaugh, Marina Del Rey, CA (US); Eric Hodonsky, Studio City, CA (US)

(21) Appl. No.: 18/339,992

(22) Filed: Jun. 22, 2023

(51) Int. Cl. B60L 53/66; B60L 53/18; G06F 8/65; G06Q 20/32; G06Q 20/38

(52) U.S. Cl. CPC B60L 53/665; B60L 53/18; G06F 8/65; G06Q 20/32; G06Q 20/38215; B60L 2240/70

(57) ABSTRACT

Aspects of the disclosed technology provide solutions for updating and facilitating payment settlement for an Electric Vehicle Service (EVSE) device using peer-to-peer communications such as a gossip network. In some approaches, a process of the disclosed technology can include steps for establishing a connection with a wireless device, wherein the wireless device is running an Open Charge Point Protocol (OCPP) service, validating a user identity (ID) for at least one user associated with the wireless device, and determining if updates are available for one or more software or firmware components of a charging station management system (CSMS) of an Electric Vehicle Service Equipment (EVSE) device. In some aspects the process can further include transferring the updates from the wireless device to the EVSE, if updates are available. Systems and machine-readable media are also provided.

### BACKGROUND

### 1. Technical Field

The present disclosure generally relates to peer-to-peer connectivity for Electric Vehicle Service Equipment (EVSE) devices and in particular, for providing updates and facilitating payment settlement using peer-to-peer communications such as a gossip network.

### 2. Introduction

Electric vehicles (EVs) require charge storage devices, commonly batteries, which need to be periodically recharged. While standard home outlets can be used for charging, it may take several hours (8 or more) to completely charge an electric vehicle. As EV usage continues to grow, specialized charging setups or charging stations are becoming more common. These stations are wired directly to power lines and can charge EVs at a much faster rate than standard home outlets. Electric Vehicle Service Equipment (EVSE), commonly referred to as charging stations, typically consist of a dispenser that connects to the electric vehicle through a charging cable, and power conversion electronics housed in either the dispenser or a separate cabinet. Dispensers are commonly located in designated charging locations, such as near parking spaces in public or private areas.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail using the accompanying drawings in which:

FIG. 1A illustrates an example network that can be used to facilitate communication between different network nodes, including various nodes in a peer-to-peer network, such as a gossip network.

FIG. 1B illustrates an example of a gossip network, including a wireless device and an Electric Vehicle Service Equipment (EVSE) device), according to some aspects of the disclosed technology.

FIG. 2 illustrates an EV charging system in which a gossip network can be used to facilitate Electric Vehicle Service Equipment (EVSE) device updates and payment settlement, according to some examples of the present disclosure.

FIG. 3 illustrates an example communication diagram for updating an EVSE, according to some aspects of the disclosed technology.

FIG. 4 illustrates a process of updating an EVSE using a gossip network, according to some aspects of the disclosed technology.

FIG. 5 illustrates an example communication diagram for authorizing an EVSE payment transaction, according to some aspects of the disclosed technology.

FIG. 6 illustrates steps of an example process for authorizing an EVSE payment transaction, according to some aspects of the disclosed technology.

FIG. 7 illustrates an example of a processor-based device that can be used to facilitate various aspects of the disclosed technology.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form to avoid obscuring the concepts of the subject technology.

One limitation in deploying electric vehicle charging stations is that Internet connectivity is often unavailable in common charging locations, such as in parking garages or in remote locations, making it difficult to provide over-the-air (OTA) software updates to the EVSE, and/or communicate with third-party services to settle charging payment transactions.

The disclosed technology provides solutions for communicating with EVSE devices using peer-to-peer communications, for example, in which trusted wireless devices (such smartphones, or tablet computing devices) communicate on a peer-to-peer basis in order to connect with the EVSE. Once communication between the wireless device and the EVSE has been established, information, such as software updates and payment transaction information, can be transacted with the EVSE. Through peer-to-peer communication with trusted wireless devices, information can ultimately be exchanged between the EVSE and various Internet connected devices/services, even when a direct Internet connection is not available to the EVSE. For example, software updates (including firmware updates) may be provided to a trusted wireless device, such as a smartphone or other mobile device from an Internet connected server. When the trusted device is in range of the EVSE, the update information may be communicated to the EVSE. Depending on the desired implementation, communication between the EVSE and the wireless device may be accomplished using Bluetooth, Bluetooth Low Energy (BLE), Near Field Communications (NFC), Wi-Fi, Zigbee, a Dedicated Short-Range Communications (DSRC) service, or the like.

Direct connections with the EVSE can also be used to facilitate the settlement of payment transactions, such as for charging services rendered to an EV owner using the EVSE. For example, payment settlement information may be stored on the user's wireless device and then provided to a third-party settlement system (or payment server), by the wireless device, once Internet connectivity becomes available to the wireless device. In some approaches, one or more intermediary data transfers may occur before payment settlement information is transmitted to the payment server for final settlement. For example, a user may charge a vehicle and receive/store payment settlement information in their own device (e.g., a first wireless device). Subsequently, the first wireless device may come into proximity of another trusted wireless device (e.g., a second wireless device) and may transfer the payment settlement information to the second device, after which the payment settlement information can be directly transmitted to the payment server by the second wireless device. It is understood that any number of intervening nodes (e.g., wired, or wireless devices) may be used to facilitate transport of the payment settlement information to the payment server.

Irrespective of the number of peer-to-peer transfers needed, payment authorization can be completed by a user device that does not have direct internet connectivity. Further to the above example, the first user device can be configured to communicate directly with the EVSE and to authorize charging services, without the need for the EVSE and/or the first wireless device to communicate with the payment server. As such, users can easily pay for charging services at EVSEs located in areas without reliable network connectivity, such as in parking garages, or in remote locations without cellular/Internet access. As discussed in further detail below, payment settlement can be facilitated using an Open Charge Point Protocol (OCPP) service that is running on the user's wireless device, and which is configured to authorize/validate a payment from the user's account through direct communication with the EVSE.

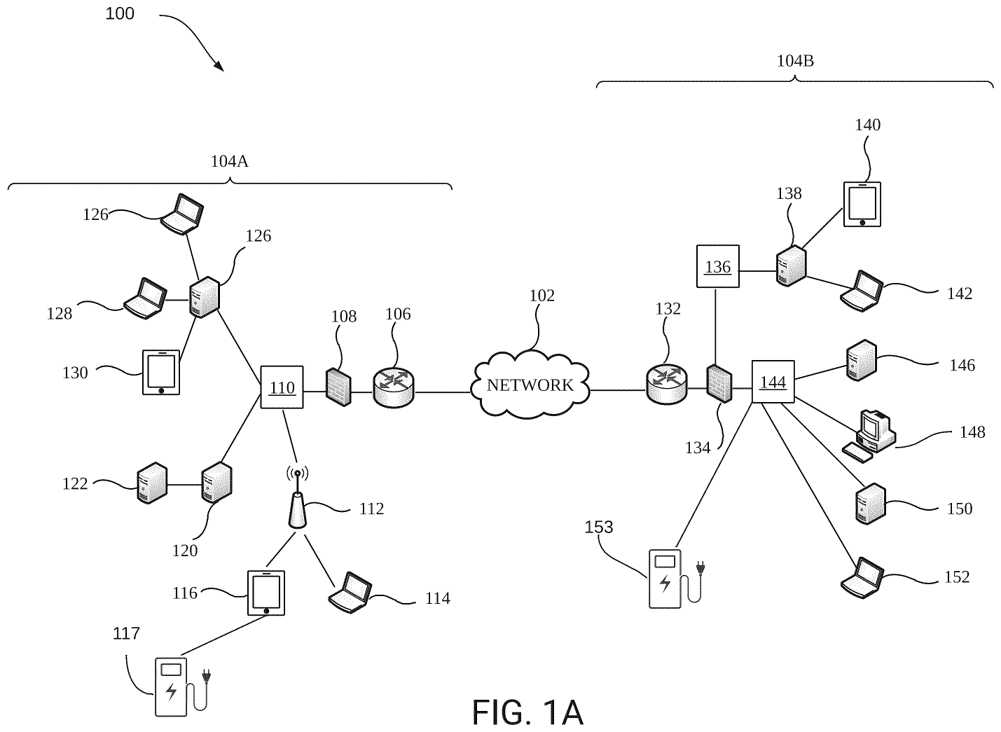

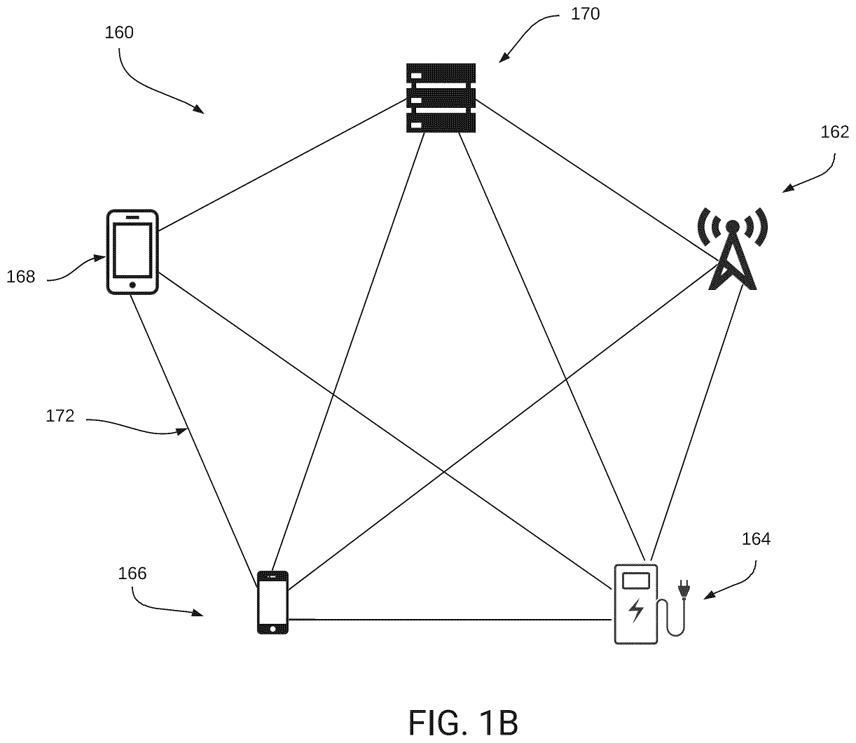

FIG. 1A illustrates an example network environment 100, in which peer-to-peer communication between network nodes can be used to transact data with an EVSE, e.g., EVSE 117 and/or EVSE 153. Network environment 100 can include one or more networks, such as networks 104A and 104B, which in turn can include one or more local area network (LAN), virtual LANs, wireless networks, physical network segments, logical network segments, underlay networks, overlay networks, etc. Each of the networks 104A and 104B can also include one or more physical and/or logical network segments. For example, networks 104A and 104B can be segmented into VLANs to separate traffic within the networks. Moreover, networks 104A and 104B can be interconnected by network 102, which can include a private network, such as a LAN, and/or a public network, such as the Internet.

Networks 104A and 104B can include various devices 114-117, 120-122, 126-130, 138-142, 146-153, such as servers and client devices, interconnected via network devices 106-110, 112, 132-136, 144, and 145 such as routers, firewalls, switches, and so forth. Networks 104A and 104B can also include a cluster of nodes. Devices 106-117, 120-130, 132-153 and networks 102 and 104A-B in network environment 100 are non-limiting examples of nodes and networks provided for clarity and explanation purposes. As discussed in further detail below, network devices of network 100 can be configured to communicate on an ad hoc basis, for example, using a peer-to-peer protocol, such as a gossip protocol, to update various devices/nodes regarding changing state information in the network 100.

One of ordinary skill in the art will readily recognize that network environment 100 can include more or less devices than those depicted in FIG. 1A. Moreover, one of ordinary skill in the art will readily recognize that network environment 100 can include other configurations, architectures, topologies, and so forth. Indeed, other configurations, architectures, topologies, systems, and implementations are contemplated herein.

FIG. 1B illustrates a schematic diagram of an example cluster 160 of nodes. Cluster 160 can include nodes 162-170 within an environment, such as network 100. Nodes 162-170 can be interconnected by connections 172 that are supported using one or more protocols, networks, media, mechanism, etc. For example, the connections 172 interconnecting nodes 162-170 can be wireless or wired connections established using one or more network protocols, such as transmission control protocol (TCP) or user datagram protocol (UDP), for example.

Moreover, nodes 162-170 in cluster 160 can include one or more client devices, such as laptops or tablet computers; one or more servers, such as application or database servers; one or more network devices, such as routers, switches, hubs, firewalls, or bridges; one or more resources, such as network printers or storage devices; application-based tools or platforms, such as endpoint groups; and/or virtual nodes, such as virtual machines.

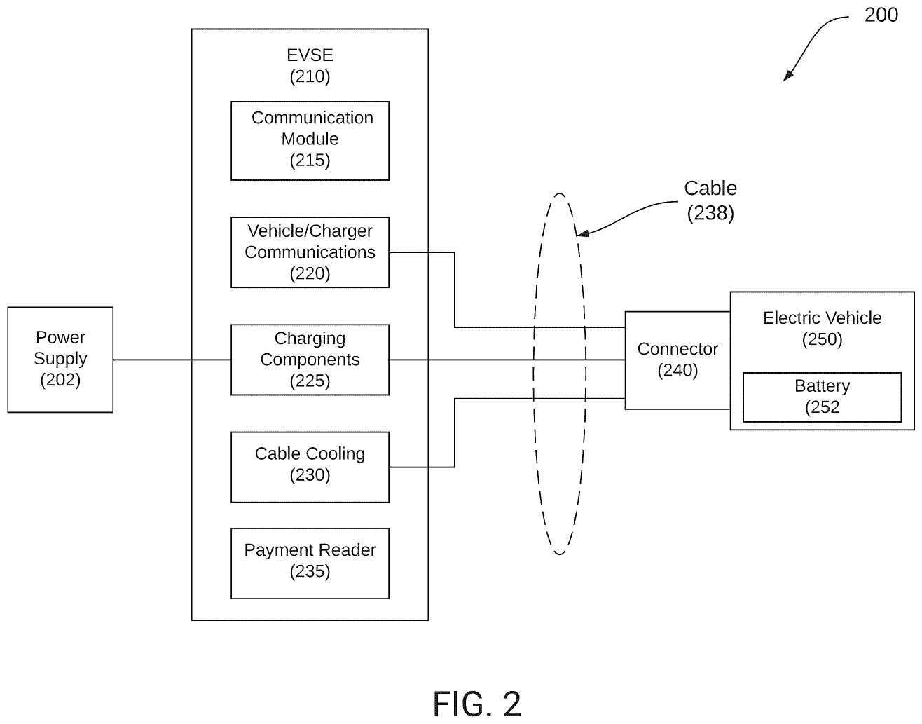

In some embodiments, nodes 162-170 can communicate and/or synchronize data and commands, such as remote procedure calls (RPCs), configuration information, logs, registries, statistics, alerts, notifications, messages, settings, files, etc., with each other. For example, in some cases, nodes 162-170 can synchronize a registry of RPC data with each other. Synchronization of data or commands between the nodes 162-170 in cluster 160 can be performed using broadcast communications, direct communications, or any other specific communication protocol. In some cases, nodes 162-170 can communicate or synchronize data using a gossip protocol. By way of example, a gossip protocol can be used to transmit data (e.g., software updates and/or payment information) between an Internet connected server 170, such as an OCPP payment server or other Internet service and EVSE 164, even when direct connections between server 170 and EVSE 164 are not available. Additionally, state information from various nodes can be used to transmit data from any device to any other device, without the availability of a direct connection. For example, payment information arbitrated between EVSE 164 and wireless device 166 may be communicated back to server 170 via device 168 for final settlement. Further details regarding communications between an OCPP server (e.g., server 170) and an EVSE (e.g., EVSE 164) are discussed in further detail with respect to FIGS. 2-4.

As one of ordinary skill in the art will readily recognize, cluster 260 of nodes can include a greater (or fewer) number nodes and/or connections. Nodes 262-270 and connections 272 are non-limiting examples provided for explanation purposes.

FIG. 2 illustrates an example electric vehicle (EV) charging system 200, in which a gossip network can be used to facilitate software updates and payment settlement with an electric vehicle system equipment (EVSE) 210. Charging system 200 is configured to deliver power from an AC source (e.g., AC power supply 202), to electric vehicle 250 via EVSE 210. For example, EVSE 210 can connect to electric vehicle 150 through connector 240 of cable 238. Electric vehicle 250 is a vehicle that includes a rechargeable battery 252 that powers propulsion of the vehicle. Electric vehicle 250 may be an all-electric vehicle that uses one or more electric motors powered from the battery system. Alternatively, electric vehicle 250 may be a hybrid electric vehicle that can use a combustion engine and one or more electric motors for propulsion. By way of example, electric vehicle 250 may include an automobile, a truck, a bus, a train, an aircraft, a ship, or a tank, or the like, without departing from the scope of the disclosed technology. Additionally, battery 252 can include one or more charge storage cells, such an array of batteries, without departing from the scope of the disclosed technology.

In operation, EVSE 210 supplies power to battery 252 through cable 238. Power management is performed by EVSE 210 using charging components 225 that manage charging of battery 252. Charging components 225 may include switches/relays, meter(s), and other electronics for managing charging of electric vehicles. By way of example, charging components 225 may be configured to deliver direct current (DC) power or alternating current (AC) power to electric vehicle 250, depending on the desired implementation. Additionally, charging components 225 may include multiple power connections to charge multiple batteries of electric vehicle 250 simultaneously and possibly at different current rates and/or voltages.

To initiate a charging session, EVSE 210 includes vehicle/charger communications 220 that allows the EVSE 210 to communicate charging parameters and status with electric vehicle 250. For instance, vehicle/charger communications 220 may handle communication according to the SAE J1772 standard, the CHAdeMO standard, the Type 2 standard, and/or other communication standards. In some instances, payment for charging services may be validated using a user or vehicle identifier that is received by vehicle/charger communications 220 from EV 250. In such approaches, the user or vehicle identifier (or other payment processing information) can be communicated by EVSE 210 to one or more third-party servers or systems, via communication module 215, to settle the transaction. In other approaches, payment transactions may be authorized directly between EVSE 210 and a wireless device (such as a user's smartphone, not illustrated), without communicating with a third-party payment server. In such instances, a payment transaction may be authorized through direct communication with the user's wireless device, such as by authorizing the transaction using an OCPP service running on the user's device.

Communication module 215 may also be used to receive data from an external source, such as to receive over-the-air (OTA) updates to one or more software modules of EVSE 210. Updates may also be received from a directly connected wireless device. As such, EVSE 210 and/or an OCPP client service running on the EVSE 210 can be updated periodically without the need for direct or consistent Internet access. In some approaches, updates may only be received by EVSE 210 from authenticated or verified devices. For example, a wireless device may provide a digital certificate or other authentication credential to EVSE 210, in order to identify the wireless device, a OCPP service running on the wireless device, a user associated with the wireless device, or to validate/authenticate updates that are to be provided to EVSE 210. In this manner, EVSE 210 can ensure that updates are only received from a trusted source, and/or that only trusted updates (e.g., that have been digitally signed from a trusted source) are downloaded and installed.

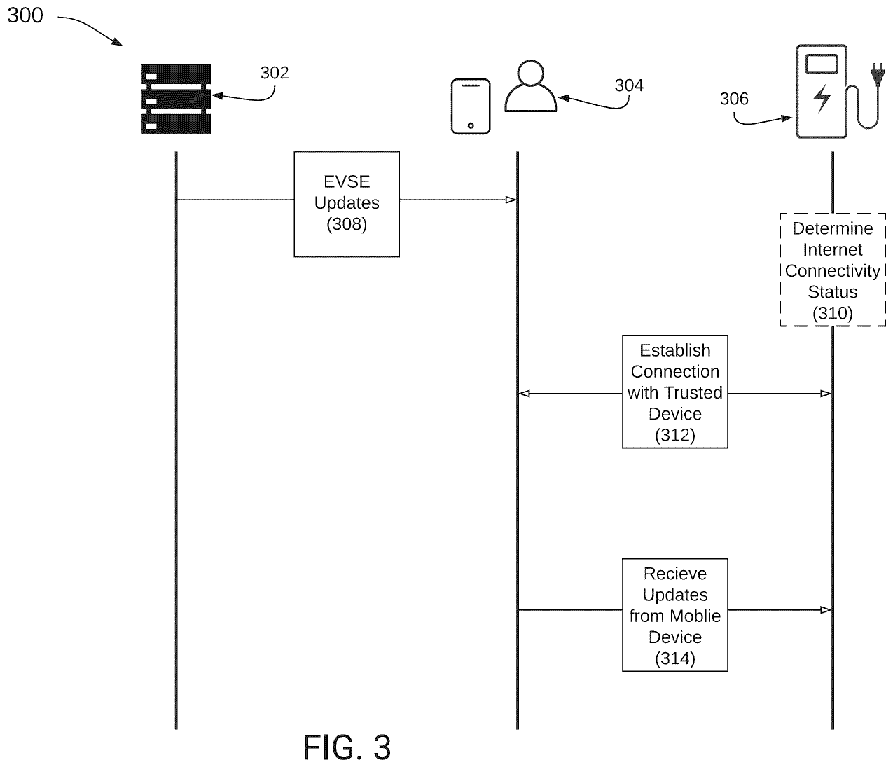

FIG. 3 illustrates an example communication diagram 300 of a process for updating an EVSE using a gossip network. In the example of FIG. 3, an Internet connected server 302, which can be (or may include) an OCPP server, can communicate EVSE updates 308 to a wireless device 304. The updates can include software and/or firmware updates to one or more software components of the EVSE. For example, the update package may include software updates for OCPP client software that is running on the EVSE.

Wireless device 304 may be authenticated by the OCPP server 302 before the updates are transmitted, for example, to determine or validate that the device is associated with a valid user account by the OCPP server 302. In such approaches, a digital certificate, e.g., that is stored on the wireless device, may be used by the EVSE to verify a trustworthiness of the wireless device and/or software updates provided by the wireless device. Depending on implementation, the EVSE updates can include software/firmware updates to one or more EVSE software/firmware modules.

At optional step 310, EVSE 306 can determine if Internet/network access is available, for example, to exchange data with OCPP server 302. In some approaches, if it is determined that Internet/network access is available, EVSE 306 may communicate directly with OCPP server 302 (e.g., via the Internet) to receive any necessary software/firmware updates. Alternatively, if it is determined that OCPP server 302 cannot be reached, then EVSE 306 can establish a connection with wireless device 304 (block 312). In some approaches, EVSE 306 can be configured to validate/authenticate the wireless device 304, for example, to ensure that the device is associated with a valid user or user account. User/device validation can be performed using a certificate that is stored on wireless device 304 and that can be exchanged with and verified by EVSE 306.

Once a connection is established between wireless device 304 and EVSE 306, updates received at wireless device 304 from OCPP server 302 can be transferred to EVSE 306 (block 314). In this manner, EVSE 306 can receive OTA updates without the need for Internet access or network connectivity directly to OCPP server 302. In some instances, software versioning information for EVSE 306 may be communicated back to mobile device 304, and then retransmitted back to OCPP server 302, for example, to maintain versioning status information for EVSE 306.

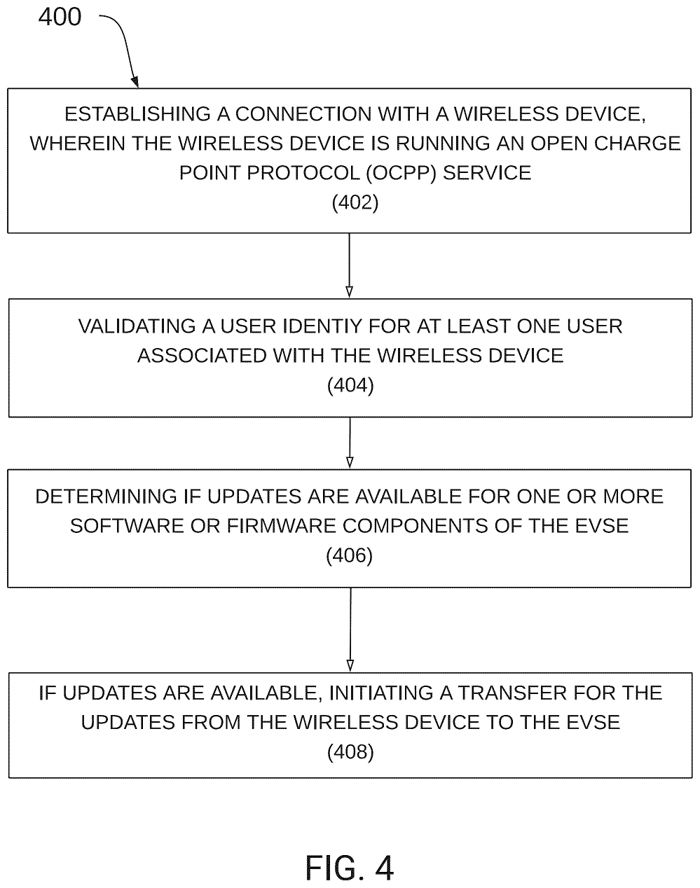

FIG. 4 illustrates a process of updating an EVSE using a gossip network. At step 402, process 400 includes establishing a connection with a wireless device. The wireless device can be configured to run an Open Charge Point Protocol (OCPP) service. The OCPP service can be configured to mediate communications between an OCPP server, such as server 302 discussed above, and an OCPP client instance running on the EVSE. The OCPP service can facilitate the settlement of payment transactions with an EVSE, for example, without the need for the EVSE to first communicate with one or more third-party systems, such as server 302.

At step 404, process 400 includes validating a user identity for at least one user associated with the wireless device. Validation may be performed using a secure certificate that identifies the user, device, and/or OCPP service on the wireless device. By validating the wireless device (and/or the OCPP service), the EVSE (or OCPP client running on the EVSE), can verify that any updates received from the wireless device can be trusted for later installation.

At step 406, the process 400 includes determining if updates are available for one or more software and/or firmware components of the EVSE. In some approaches, versioning information associated with software/firmware of the EVSE may be used to determine, by the wireless device, if updates are available for the EVSE. In other approaches, the EVSE (or OCPP client on the EVSE) may determine if information/updates residing on the wireless device can/should be downloaded to the EVSE.

At step 408, the process 400 includes initiating a transfer for the updates from the wireless device to the EVSE, if updates are available. Depending on the desired implementation, software/firmware updates may include code or other computer instructions that partially (or entirely) replace one or more software modules or packages on the EVSE. Data transfers between the wireless device and the EVSE can be supported using any wireless communication means available, including but not limited to Bluetooth, Bluetooth Low Energy (BLE), Wi-Fi, near-field communications (NFC), ultra-wideband (UWB), Low-power WAN (LPWAN), or the like.

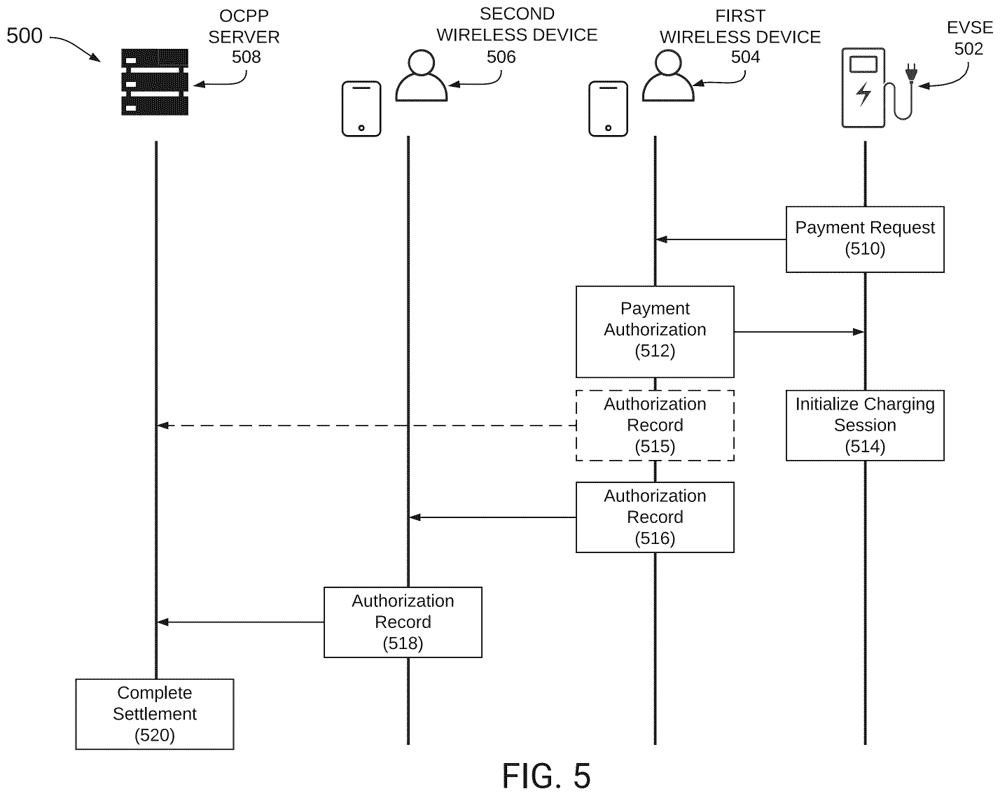

FIG. 5 illustrates an example communication diagram 500 for authorizing an EVSE payment transaction, for example, when network (Internet) access is unavailable to the EVSE. Initially, EVSE 502 may establish a connection with a proximately located wireless device e.g., first wireless device 504. Depending on the desired implementation, the direct connection may be established and maintained by a communication module (e.g., communication module 215, discussed above) using a wireless communication protocol, such as Bluetooth, Bluetooth Low Energy (BLE), Wi-Fi, near-field communications (NFC), ultra-wideband (UWB), Low-power WAN (LPWAN), or the like.

A payment request for charging services can then be provided by EVSE 502 to first wireless device 504 (block 510). First wireless device 504 can be configured to authorize the payment request with a payment authorization issued to EVSE 502, without the need to first communicate with any third-party systems or services (block 512). As such, first wireless device 504 can transmit a payment authorization back to EVSE 502, to cause EVSE 502 to initiate EV charging (block 514), without the need to first contact OCPP server 508. By enabling EVSE 502 to initiate a charging session without the need for final payment transaction settlement, charging services can be provided to customers even when there is little (or no) Internet access available to EVSE 502.

First wireless device 504 may eventually communicate an authorization record of the payment authorization (at block 512) back to a third-party system, such as OCPP server 508, when network connectivity becomes available to first wireless device 504 (block 515). Alternatively, or additionally, wireless device 504 may communicate the authorization record to another wireless device (e.g., second wireless device 506) using a peer-to-peer protocol, such as a gossip protocol (block 516). In turn, second wireless device 506 can forward the payment authorization record to OCPP server 508 (block 518). Upon receipt of the payment authorization record, OCPP server 508 can settle the original payment authorization (block 520). As such, a user of wireless device 504 can complete a charging transaction, to enable the charging of an EV, using EVSE 502, without the need for wireless device 504 or EVSE 502 to have Internet access. Importantly, OCPP server can settle the charging transaction after EVSE 502 has already provided charging services.

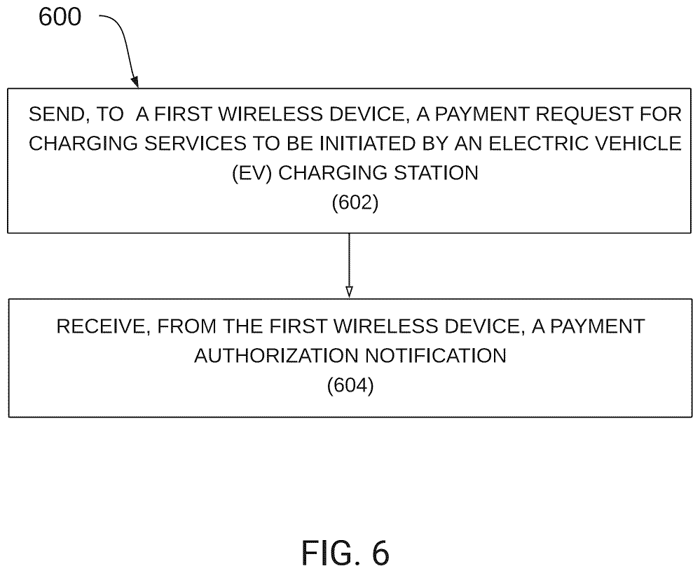

FIG. 6 illustrates steps of an example process 600 for authorizing an EVSE payment transaction. Process 600 begins with step 602 in which a charging station sends a payment request to a wireless device, e.g., to provide charging services to an EV. For example, the payment request can be for a predetermined monetary sum corresponding with an amount of charge provided to the EV. Subsequently, at step 604, the process 600 can include receiving, from the first wireless device, a payment authorization notification. Receipt of the authorization notification can allow the charging station (EVSE) to provide the requested charging services for the amount specified by the payment request. In some approaches, the wireless device may later communicate a record of the authorization notification to an Internet connected OCPP server, for example, at a time after charging services have been rendered by the EVSE. Thus, charging services provided by the charging station are not contingent upon final payment settlement, e.g., by an OCPP server.

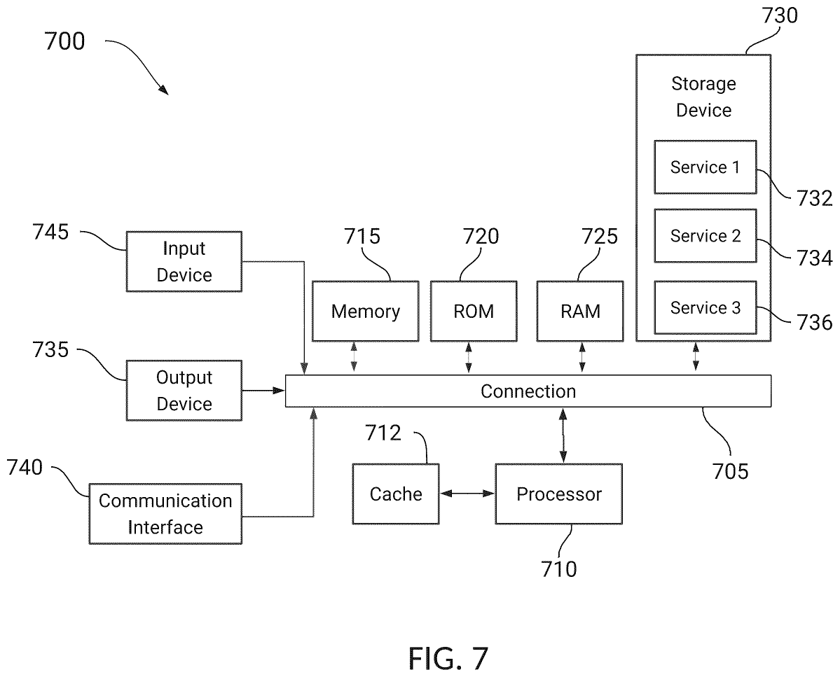

FIG. 7 illustrates an example processor-based system with which some aspects of the subject technology can be implemented. For example, processor-based system 700 can be any computing device making up, or any component thereof in which the components of the system are in communication with each other using connection 705. Connection 705 can be a physical connection via a bus, or a direct connection into processor 710, such as in a chipset architecture. Connection 705 can also be a virtual connection, networked connection, or logical connection.

In some embodiments, computing system 700 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 700 includes at least one processing unit (Central Processing Unit (CPU) or processor) 710 and connection 705 that couples various system components including system memory 715, such as Read-Only Memory (ROM) 720 and Random-Access Memory (RAM) 725 to processor 710. Computing system 700 can include a cache of high-speed memory 712 connected directly with, in close proximity to, or integrated as part of processor 710.

Processor 710 can include any general-purpose processor and a hardware service or software service, such as services 732, 734, and 736 stored in storage device 730, configured to control processor 710 as well as a special-purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction, computing system 700 includes an input device 745, which can represent any number of input mechanisms, such as a microphone for speech, a touch-sensitive screen for gesture or graphical input, keyboard, mouse, motion input, speech, etc. Computing system 700 can also include output device 735, which can be one or more of a number of output mechanisms known to those of skill in the art. In some instances, multimodal systems can enable a user to provide multiple types of input/output to communicate with computing system 700. Computing system 700 can include communications interface 740, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 740 may also include one or more Global Navigation Satellite System (GNSS) receivers or transceivers that are used to determine a location of the computing system 700 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 730 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Atatic RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5), Resistive RAM (RRAM/ReRAM), Phase Change Memory (PCM), Spin Transfer Torque RAM (STT-RAM), another memory chip or cartridge, and/or a combination thereof.

Storage device 730 can include software services, servers, services, etc., that when the code that defines such software is executed by the processor 710, it causes the system 700 to perform a function. In some embodiments, a hardware service that performs a particular function can include the software component stored in a computer-readable medium in connection with the necessary hardware components, such as processor 710, connection 705, output device 735, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be in both local and remote memory storage devices.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

What is claimed is:

1. An electric vehicle service equipment (EVSE) device, comprising:
at least one memory;
a communication module; and
at least one processor coupled to the at least one memory and the communication module, the at least one processor configured to:
establish a connection with a wireless device, wherein the wireless device is running an Open Charge Point Protocol (OCPP) service;
validate a user identity (ID) for at least one user associated with the wireless device;
determine if updates are available for one or more software or firmware components of a charging station management system (CSMS) of the EVSE; and
if updates are available, initiating transfer for the updates from the wireless device to the EVSE.

2. The EVSE of claim 1, wherein the connection with the wireless device is established using a short-range wireless protocol.

3. The EVSE of claim 2, wherein the short-range wireless protocol comprises at least one of: Bluetooth, Bluetooth Low Energy (BLE), Wi-Fi, near-field communications (NFC), ultra-wideband (UWB), or Low-power WAN (LPWAN).

4. The EVSE of claim 1, wherein to determine if updates are available for one or more software or firmware components of the EVSE, the at least one processor is configured to:
determine if an Internet connection is available to the EVSE, and wherein initiating transfer for the updates from the wireless device to the EVSE is performed if an Internet connection is not available to the EVSE.

5. The EVSE of claim 1, further comprising:
a charger communications module coupled to the at least one processor, wherein the charger communications module is configured to communicate with an electric vehicle (EV) via a charging cable that is configured to deliver power from the EVSE to the EV.

6. The EVSE of claim 1, wherein to validate a user identity (ID) for at least one user associated with the wireless device, the at least one processor is further configured to:
receive a digital certificate from the wireless device, wherein the digital certificate is configured to validate an instance of the OCPP service on the wireless device.

7. The EVSE of claim 1, further comprising:
one or more charging components coupled to the at least one processor, wherein the one or more charging components are configured to deliver direct current (DC) power to an electric vehicle (EV).

8. A non-transitory computer-readable storage medium comprising at least one instruction for causing a computer or processor to:
establish a connection with a wireless device, wherein the wireless device is running an Open Charge Point Protocol (OCPP) service;
validate a user identity (ID) for at least one user associated with the wireless device;
determine if updates are available for one or more software or firmware components of a charging station management system (CSMS) of an Electric Vehicle Service Equipment (EVSE) device; and
if updates are available, initiating transfer for the updates from the wireless device to the EVSE.

9. The non-transitory computer-readable storage medium of claim 8, wherein the connection with the wireless device is established using a short-range wireless protocol.

10. The non-transitory computer-readable storage medium of claim 9, wherein the short-range wireless protocol comprises at least one of: Bluetooth, Bluetooth Low Energy (BLE), Wi-Fi, near-field communications (NFC), ultra-wideband (UWB), or Low-power WAN (LPWAN).

11. The non-transitory computer-readable storage medium of claim 8, wherein to determine if updates are available for one or more software or firmware components of the EVSE, the at least one instruction is configured to cause the computer or processor to:
determine if an Internet connection is available to the EVSE, and wherein initiating transfer for the updates from the wireless device to the EVSE is performed if an Internet connection is not available to the EVSE.

12. The non-transitory computer-readable storage medium of claim 8, wherein the at least one instruction is configured to cause the computer or processor to:
communicate with an electric vehicle (EV) via a charging cable that is configured to deliver power from the EVSE to the EV.

13. The non-transitory computer-readable storage medium of claim 8, wherein to validate a user identity (ID) for at least one user associated with the wireless device, the at least one instruction is further configured to cause the computer or processor to:
receive a digital certificate from the wireless device, wherein the digital certificate is configured to validate an instance of the OCPP service on the wireless device.

14. The non-transitory computer-readable storage medium of claim 8, wherein the at least one instruction is further configured to cause the computer or processor to:
deliver direct current (DC) power to an electric vehicle (EV) using one or more charging components coupled to the at least one processor.

15. A computer-implemented method comprising:
establishing a connection with a wireless device, wherein the wireless device is running an Open Charge Point Protocol (OCPP) service;
validating a user identity (ID) for at least one user associated with the wireless device;
determining if updates are available for one or more software or firmware components of a charging station management system (CSMS) of an Electric Vehicle Service Equipment (EVSE) device; and
if updates are available, transferring the updates from the wireless device to the EVSE.

16. The computer-implemented method of claim 15, wherein the connection with the wireless device is established using a short-range wireless protocol.

17. The computer-implemented method of claim 16, wherein the short-range wireless protocol comprises at least one of: Bluetooth, Bluetooth Low Energy (BLE), Wi-Fi, near-field communications (NFC), ultra-wideband (UWB), or Low-power WAN (LPWAN).

18. The computer-implemented method of claim 17, wherein determining if updates are available for one or more software or firmware components of the EVSE, further comprises:
determining if an Internet connection is available to the EVSE, and wherein initiating transfer for the updates from the wireless device to the EVSE is performed if an Internet connection is not available to the EVSE.

19. The computer-implemented method of claim 15, further comprising:
communicating with an electric vehicle (EV) via a charging cable that is configured to deliver power from the EVSE to the EV.

20. The computer-implemented method of claim 15, wherein validating a user identity (ID) for at least one user associated with the wireless device, further comprises:
receiving a digital certificate from the wireless device, wherein the digital certificate is configured to validate an instance of the OCPP service on the wireless device.
